(19) United States
(12) Patent Application Publication
(10) Pub. No.: US 2015/0306840 A1
(43) Pub. Date: Oct. 29, 2015

(54) Sturdy Gypsum Composite Decorative Surface and Method for Making Sturdy Gypsum Composite Decorative Surface

(71) Applicant: Samuel Joseph Ferguson, JR., Vero Beach, FL (US)

(72) Inventor: Samuel Joseph Ferguson, JR., Vero Beach, FL (US)

(21) Appl. No.: 14/699,524

(22) Filed: Apr. 29, 2015

Related U.S. Application Data
(60) Provisional application No. 61/985,545, filed on Apr. 29, 2014.

(51) Int. Cl. B32B 3/12; B32B 3/04; B32B 29/00; B32B 38/00; B32B 15/20; B32B 5/02; B32B 37/24; B32B 13/06; B32B 3/26

(52) U.S. Cl. CPC B32B 3/12; B32B 13/06; B32B 3/04; B32B 29/002; B32B 3/266; B32B 15/20; B32B 5/028; B32B 37/24; B32B 38/0004; B32B 2255/00; B32B 2451/00; B32B 2305/024; B32B 2262/101; B32B 2037/243; B32B 2479/00

(57) ABSTRACT

Composite material which may be used for table tops, counter tops, backsplashes, and other horizontal or vertical decorative surfaces comprising a reinforced core panel, top, bottom, and perimeter gypsum layers, core primer layer, a printed decorative, and at least one sealant layer, with optional gypsum support columns.

A method of making a decorative composite panel including depositing wet-cast polymer-modified alpha gypsum cement slurry then a reinforced core panel into a frame or mold, pouring additional wet-cast polymer-modified alpha gypsum cement slurry to fill the frame or mold, applying a thermoset primer and a decorative printed layer, then applying a transparent sealant. The reinforced core panel may be comprised of a fiber-reinforced paper honeycomb sandwich, which may have holes drilled into it to allow for flow of the wet-cast gypsum into those holes.

### CROSS-REFERENCE TO RELATED APPLICATION

This application claims the benefit of U.S. Provisional Application No. 61/985,545, filed Apr. 29, 2014, which is incorporated herein by reference.

### BACKGROUND OF THE INVENTION

This invention is designed to solve the lack of structural integrity, longevity, reasonable price, reasonable weight, and appearance associated with current exterior decorative table tops or panels.

Most decorative outdoor table tops or panels are manufactured with traditional materials such as fiberglass, plastics, and finishes that will not endure the harsh environment and extreme weather conditions. The current outdoor decorative table tops or panels do not weather well or maintain optical clarity in direct sun UV exposure or climate conditions. High-end materials, such as granite and other stone materials are heavy, expensive, and cannot be easily modified or repaired. The weight associated with natural stone materials makes it difficult to use in many heavy-use commercial environments, where flexibility of use and mobility can be key issues. Because of their weight, stone materials can be damaged or broken by being dropped during transit or when moving. Such materials cannot be easily repaired, so damage to such surfaces often requires full replacement.

Wood composites, though lightweight, are not fire-resistant, and often do not have sufficient structural integrity and water resistance to withstand repeated weathering and heavy daily use.

Exterior decorative table tops or panels in the prior art commonly fail after a short period of time when used outdoors due to inferior materials and manufacturing methods. Thus, there exists a need to provide a durable, rigid, reparable, and high-aesthetic quality table top, counter top, and other rigid surfaces at a reasonable price.

### BRIEF SUMMARY OF THE INVENTION

This invention uses advanced manufacturing methods, chemicals, and materials that are designed for extreme exterior long term exposure and will provide many years of usage while maintaining a quality appearance, structural integrity, relatively light weight, with reparability at a reasonable price point.

The invention includes a composite material comprising a reinforced core panel, top and bottom gypsum layers and a perimeter gypsum layer, a core primer layer over the top and optionally perimeter gypsum layer, a printed decorative layer over the core primer layer, and at least one sealant layer. The composite material may also have gypsum support columns throughout extending from the top gypsum layer to the bottom gypsum layer. The gypsum support columns, along with the top gypsum layer, bottom gypsum layer, and perimeter gypsum layer may form a single unitary cast structure.

The invention also includes a method of making a composite panel comprising depositing wet-cast polymer-modified alpha gypsum cement slurry in a frame or mold, inserting a reinforced core panel into the mold over the initial quantity of slurry, depositing additional wet-cast polymer-modified alpha gypsum cement slurry to fill the frame or mold, removing the now solidified gypsum base from the mold, applying a thermoset primer to at least one surface of the gypsum base, then applying a decorative printed layer and a transparent sealant. The reinforced core panel may be comprised of a kraft paper honeycomb sandwich, which has been reinforced with fiberglass on the top and bottom flat surfaces. The reinforced core panel may also have holes drilled into it to allow for flow of the wet-cast gypsum into those holes, thus forming gypsum support columns throughout that will increase the structural stability of the composite panel.

### BRIEF DESCRIPTION OF THE SEVERAL VIEWS OF THE DRAWINGS

FIG. 1 is a flow chart of method embodiments of the present invention.

FIG. 2 is a cross section view of a composite surface according to another embodiment of the present invention.

FIGS. 3 and 4 are a side view and top view, respectively of a finished composite table top surface according to an embodiment of the present invention.

FIG. 5 is a flow chart of a method of manufacturing a fiberglass reinforced according to several embodiments of the present invention.

### DETAILED DESCRIPTION OF THE PREFERRED EMBODIMENTS OF THE INVENTION

The present invention now will be described more fully hereinafter with reference to the accompanying drawings, in which preferred embodiments of the invention are shown. The invention may, however, be embodied in many different forms and should not be construed as limited to the embodiments set forth herein; rather, these embodiments are provided so that this disclosure will be thorough and complete and convey the scope of the invention to those skilled in the art. Like numbers refer to like elements throughout.

As stated above, this invention is designed to solve the lack of structural integrity, longevity and appearance associated with current exterior decorative table tops or panels. The invention and its embodiments claimed here solves this problem.

This invention solves the durability and maintenance issues commonly experienced with current decorative outdoor table tops and panel products. Embodiments of the invention will offer unlimited digital printed decorative design options and all weather applications not available with current decorative outdoor table tops or panel products.

Embodiments of the claimed invention differ from what currently exists. Embodiments of this invention differ from all current decorative outdoor table tops or panels due to the invention's unique method of manufacturer utilizing polymer modified alpha gypsum cement, fiber reinforced paper honeycomb core, digital design decorative printing on proprietary scrim, and structurally balanced encapsulation of highly durable and superior optical clarity cast polymer resin. This invention is an improvement on what currently exists.

Embodiments of this invention use advanced manufacturing methods, and chemicals and materials that are designed for extreme exterior long term exposure and that will provide many years of usage while maintaining a quality appearance and structural integrity.

One embodiment of the invention includes a composite countertop. Another embodiment of the invention is a method for manufacturing the composite countertop. There are multiple variations and embodiments of the invention, but both the composite countertop and the method for manufacturing said countertop as an embodiment of the invention is best understood by means of a first and second example embodiments. The version of the embodiments of the invention discussed initially here includes as materials:

1. Alpha Gypsum Cement, also known as alpha hemihydrate, or merely gypsum.

### 2. Acrylic Polymer Emulsion

### 3. Epoxy Resin

### 4. Polyurethane Resin

### 5. Poly-Isocyanate

### 6. Fiber Glass Scrim

### 7. Polyaspartic Aliphatic Polyurea

### 8. UV Curable Polymers

### 9. Water Borne Polymers

### 10. Paper Honey Comb Panels

### 11. FluoroPolymers

12. Iron Oxide and other Pigments

### 13. RTV Silicone Rubber Mold Making Compound

### 14. Polyester/Rayon 10 Mil Scrim

### 15. UV Printing on Scrim

### 16. Dye Sublimation Printing on Scrim

17. Tri-Functional Polyaziridine additive

### Method of Making Composite Surfaces

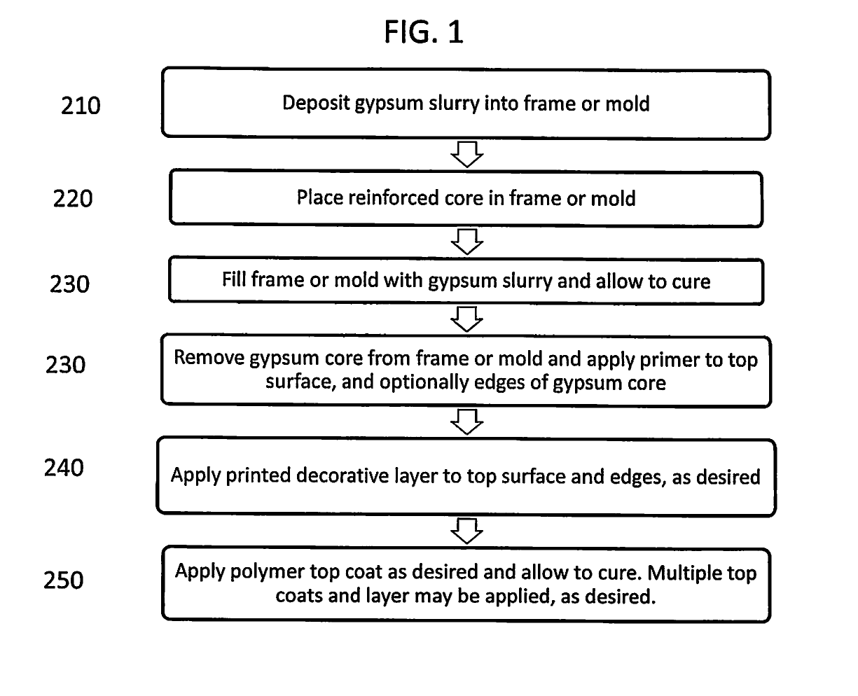

The claimed invention also includes methods of manufacturing a countertop or tabletop. The basic steps for manufacture of a countertop or table top in accordance with embodiments of the invention is presented in FIG. 1. As shown in FIG. 1, method embodiments of the invention include depositing an aliquot of gypsum slurry into a frame or mold 210. Then a reinforced core is placed in the mold atop the aliquot of gypsum slurry 220. The frame or mold is then filled with gypsum slurry and allowed to cure 230. Once cured, the gypsum base is removed from the mold or frame, and a primer is applied 240 to at least one surface of the gypsum base and allowed to cure. A printed decorative layer is then applied 250 over the primed surface of the gypsum base. At least one polymer topcoat is then applied 260 over the printed design-decorated scrim.

This invention provides a method and manufacturer of a unique and durable decorative outdoor table tops or panels that is developed by utilizing polymer modified alpha gypsum cement and a fiber-reinforced resin treated paper honeycomb core material, a polymer modified alpha gypsum cement composition is a wet cast into a silicone rubber resilient mold of desired shape or form and primed with a 2k polymer that is covered with a digital design decorative printed scrim applied with 2K water based clear polymer adhesive and put into a silicone rubber resilient mold or form to encapsulate a clear polymer casting resin that is top coated with a clear polymer for added durability, sheen adjustment and visual balance.

A preferred embodiment invention includes a method of manufacturing a table top or countertop comprising the following general steps to assemble the countertop or tabletop composite:

1. Pour or otherwise deposit an aliquot of wet cast polymer modified alpha gypsum cement face coat slurry cast into a silicone rubber resilient mold with desired shape or form.
2. Insert fiber-reinforced resin treated paper honeycomb core into silicone rubber resilient mold.
3. Pour or otherwise deposit or back-coat the fiber-reinforced resin treated paper honeycomb core with additional wet cast polymer modified alpha gypsum cement. Coat the sides and any visible voids within the fiber reinforced resin treated paper honeycomb core with the wet cast polymer-modified alpha gypsum cement. In most preferred embodiments, all available space in the mold is filled with the polymer-modified gypsum cement.
4. Allow the polymer-modified alpha gypsum cement to cure until fully hardened and solidified.
5. Once the polymer-modified gypsum cement has fully cured, remove the now gypsum-coated base from the mold. Prime the now cured polymer modified alpha gypsum cement table top or panel surface and edges by applying a primer coating. This primer can be any primer suitable for use on bare gypsum to prepare a suitable surface for adhering the digital-design-decorated printed scrim, or photographic film coating, used next to the gypsum surface. Preferably, such primer will both reduce the porosity of the surface to which the photographic film coating is applied and provide a surface that upon contact with the photographic film will provide or promote a cross-linking bond with such film. A 2-part (also known in the art as 2K or A&B) primer is preferably used, such as a 2K water based polymer coating. A preferred primer is a two part (A&B) epoxy primer, such as an industrial automobile primer. Preferably, the primer coating should be mixed and applied in a manner to best allow for even coating of the now-cured polymer modified alpha gypsum cement top or surface. In some embodiments, this may involve spraying the mixed primer onto the polymer modified alpha gypsum cement top surface. Allow primer to cure.
6. Apply a digital design decorative printed scrim, prepared with the desired design (see below), to surface and edges of polymer modified alpha cement table top or panel using water based 2K clear polymer adhesive to bond digital printed decorative scrim to polymer modified alpha gypsum cement table top or panel. Alternately, decorative printed layer comprised of adhesive-backed photographic film is applied by carefully aligning the layer such that the desired designs are in the proper position of the countertop, tabletop, or other intended surface, then removing the backing and carefully applying it to the surface of the table top, counter top, or panel. In preferred embodiments, the decorative printed layer may be smoothed out by applying even pressure to the top surface of it using a rolling, smoothing, or other tool or applying pressure with the hands directly to remove or minimize air pockets and maximize the contact between the decorative printed layer and the primed surface so that cross-linking may best occur between the two.
7. Place polymer modified alpha gypsum cement table top with digital printed decorative table top or panel into a silicone rubber resilient mold with desired shape or form to encapsulate with clear cast polymer resin over molded onto decorative printed fabric scrim on surface and edges of polymer modified alpha gypsum cement table top or panel.
8. Remove cured polymer modified alpha gypsum cement from silicone rubber resilient mold with desired shape or form and apply a clear polymer topcoat for added durability, visual balance, and sheen adjustment.

In most process embodiments, several preliminary steps are involved in the above-described process. The example process above refers to fiber-reinforced resin treated paper honeycomb core. By using a fiber-reinforced resin treated paper honeycomb core, both a light weight and structural integrity may be provided to the finished product. Similarly, countertop and tabletop embodiments of the invention comprise a fiber-reinforced paper honeycomb core. Embodiments of the invention include this fiber-reinforced resin treated paper honeycomb core and its manufacture, which is described below.

Similarly, variations of the above-described process, including variations in materials and methods, are described below.

Fiber-Reinforced Resin Treated Paper Honeycomb Core

A component of many embodiments of the invention includes a fiber-reinforced resin-treated paper honeycomb core. The use of a honeycomb core contributes to both the light weight and the structural integrity of embodiments of the invention. Honeycomb panels comprising layers of kraft paper with an internal closed-cell honeycomb structure with layers of kraft paper on both the top and bottom, held together by paste are available commercially in various sizes, including various lengths (including large sheets), thicknesses, and honeycomb widths. One vendor of such honeycomb panels and sheets is Honeycomb Products, Inc. Preferably, the internal honeycomb structure is comprised of hexagonal air-filled closed cells formed by the kraft paper, said cells sandwiched between at least one flat top layer comprised of kraft paper and at least one flat bottom layer comprised of kraft paper. It is understood that though “honeycomb” generally refers to hexagonal cells and is a common and structurally sound internal closed cell structure, other closed-cell structures may optionally be used. One commercial manufacturer of such honeycomb panels is Honeycomb Products, Inc., which produces and markets various sizes and shapes of honeycomb panels and sheets. For most applications of the invention, preferred thicknesses of honeycomb are about ½ inch thick to about 3 inches thick, more preferably about ¾ inch to about 1.5 inches thick, most preferably one inch thick for a finished tabletop or counter top intended to be about 1.5 inches thick. However, the thickness of the honeycomb panel or sheet selected may be adjusted to provide for a thicker or thinner finished product. For example, if the finished product is intended to be a vertical panel, such as a backsplash, wherein a thinner finished product is desired to be about ¾ inch thick, a ½ inch thick honeycomb panel (with gypsum layers on each side of the honeycomb of about ⅛ inch thick on each surface) is likely more desirable. Preferably, the honeycomb panel comprises most of the thickness of the end material. Similarly, if the intended final product is intended to be about 3 inches thick, the honeycomb panel selected for this application may be about 2 to 2.5 inches thick, preferably about 2.25 inches thick.

The honeycomb panels may be cut to the desired shape and length and thickness of the finished product, and this cutting and other preparation may be done either before or after the reinforcement material is applied. In horizontal applications of the finished product, the preferable gypsum edge thickness is about ¼ inch to about 1 inch, more preferably about ⅜ inch to about ⅝ inch, most preferably about ½ inch. The honeycomb panels are thus preferably sized to accommodate this in casting of the gypsum. That is, if a round tabletop is desired as a finished product, the honeycomb sheet should be cut in a round shape, with a radius approximately 1 inch smaller than the intended finished tabletop. Similarly, if the intended shape is an oval or rectangular (with rounded or squared corners), the honeycomb sheet should be cut to that shape with the length and width preferably about 1 inch shorter than the intended finished surface length and width. The honeycomb panels may be cut using various methods to achieve the desired shape, including but not limited to knives, die cutters, routers, and other machined or manual methods. The honeycomb panels may be cut to the desired shape then reinforced on a per-piece basis, or a large sheet of reinforced honeycomb may be processed, then cut or otherwise sized to the desired panel shape for each finished product after the fiberglass/epoxy or other reinforcement is applied.

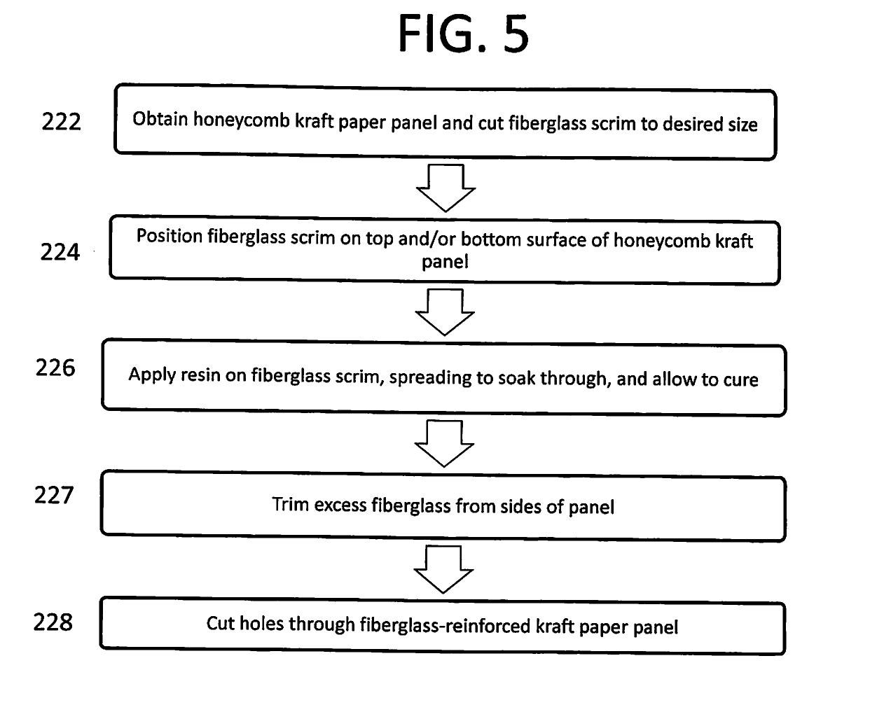

The honeycomb panels are reinforced to provide greater structural integrity than paper surfacing alone. A method of making a reinforced paper honeycomb surface is described herein and illustrated in FIG. 5. To reinforce the honeycomb panel, a fiberglass scrim or fiberglass woven cloth is cut to size 222. Various types and thicknesses of fiberglass scrim may be used to provide additional structural integrity to the honeycomb panel. There are many manufacturers of fiberglass scrim, and it is widely available in the United States for composite or reinforcement applications. Preferably, S-Cloth, also known as S-Glass or S-2 Glass or R-Glass cloth scrim is used, though E-Glass and other types of fiberglass scrim such as E-glass, A-glass, T-glass may be used. Depending on the application and cost, various thicknesses and weights of fiberglass scrim may be used, including but not limited to 4 oz., 6 oz., and 9 oz. fiberglass scrim. In preferred embodiments 4 oz. fiberglass scrim is used, though which fiberglass scrim to use may vary depending on cost constraints, strength requirements, and other variables. One, but not the only, preferred fiberglass scrim material that may be used in accordance with the invention is 4 oz S-glass plain weave scrim with thickness of 0.0058 inches, which is available commercially from several sources.

In accordance with the invention, the fiberglass scrim should be cut to cover the entire top or bottom surface of the honeycomb panel. In preferred embodiments, the fiberglass scrim is cut such that the fiberglass scrim as draped over the honeycomb panel fully covers the flat surface (top or bottom) and all sides of the cut honeycomb panel. Preferably, the fiberglass scrim is cut such that when draped over the honeycomb panel top, the scrim extends to at least 1/2 inches beyond the flat surface, more preferably about ½ inch beyond each cut surface.

The fiberglass scrim is cut to appropriate size and positioned 224 over a flat surface of the honeycomb panel, then adhered to such flat surface and sides by applying 226 a compatible thermoset resin, such as an epoxy resin or polyester resin, preferably a compatible epoxy resin (polyepoxide), more preferably a multi-part epoxy resin, even more preferably a 2-part epoxy novolac or bisphenol-A based resin. Two part, also known as 2k or A&B epoxy resins are comprised of at least two different components that are kept separate until application, then prior to application mixed together. Methods of applying 226 resin to fiberglass to form a reinforced surface are known in the art, and any appropriate method to adequately adhere and harden the fiberglass to the honeycomb panel may be used. Preferably, a resin roller is used. Typically, there is a resin component and a hardener component in 2k epoxy resins. If a 2k resin is used, it is first mixed in the appropriate proportions, usually as recommended by the manufacturer but as would be known to one skilled in the art, then applied to the fiberglass scrim. Different varieties of thermoset resins may have different properties that can aid application and end use. A medium viscosity, fast-cure resin is preferred. An example of a preferred resin is D.E.R. 331 bisphenol A resin used with an amine curative agent, such as D.E.R. amine curing agent, both manufactured by Dow Chemical. Optional accelerators and other additives may be added to the resin mixture to, for example, reduce cure time or otherwise improve properties of the process or cured resin.

Various methods of applying the resin to the positioned fiberglass scrim may be used. Preferably, the resin is applied to the fiberglass scrim by pouring, using a scraping or spreading tool, brush, roller, resin roller, squeegee, or any effective method then spread across the surface. Preferably, a resin roller is used. Preferably, enough resin is applied to adequately soak through the fiberglass, and it is spread evenly across the fiberglass surface. The resin is then allowed to fully cure. Excess fiberglass may then be trimmed 227 to fit the edge of the panel. Once the resin is cured, the now fiber-reinforced resin treated paper honeycomb panel may be used as a core for both horizontal applications, such as composite table top, countertop surface, or other sturdy flat surface, or vertical applications, such as backsplashes, paneling, columns, and other vertical or semi-vertical applications.

Multiple layers of fiber-reinforced resin treated paper may also be used as a core. For example, if a thick final surface is desired, the core may be comprised of the paper honeycomb panel described above with fiberglass reinforcement on each flat surface, plus at least one other paper honeycomb panel, either adhered to or used with the first fiber-reinforced panel, with another layer of fiberglass reinforcement deposited thereon.

Similarly, even with a single paper honeycomb core, multiple layers of fiberglass scrim reinforcement may be applied to each surface as reinforcement.

In preferred embodiments, one or more apertures or holes are made into the fiber-reinforced resin treated paper panel to provide a channel for depositing gypsum slurry in the core to further reinforce the core in the composite manufacturing process. In these embodiments, when the epoxy resin is fully cured on each surface, one or more apertures or holes are made 228 in the fiber-reinforced resin treated paper core. Such apertures may be made using various methods, including drilling, punching, scoring followed by pressure application, hole cutters, routing, CNC routing, and other known methods. The preferred methods include use of hole cutters and CNC routers. A wooden or other back board or front board may be used when drilling the aperture. It is understood that the internal diameter provided herein is the diameter of the aperture on the top or bottom surface of such, not necessarily the internal diameter, which may be wider if the treated paper has a honeycomb-shaped internal cell system. Similarly, for practical purposes in most applications an approximately circular apertures is made; however, the shape of the aperture need not be a circle, and can be any surface such as an oval or polygon or combination of curves and edges. In countertop embodiments of the present invention wherein the final thickness of the countertop is about 1.5-2 inches, the preferred diameter of an aperture is about 1 inch. However, the size of such aperture may vary, and larger apertures will provide greater structural integrity to the finished composite product. Preferably, such an aperture is made through the entire reinforced panel; that is, the channel extends through both the top and bottom surfaces of fiberglass and epoxy. However, an aperture may be made by drilling or making a hole in only one surface of the fiber-reinforced panel, and ensuring that the aperture surfaces are placed “face-up” in the mold or frame.

The number of apertures made in the fiber-reinforced resin treated paper panel may also vary by application and the degree of further reinforcement needed. As honeycomb panels comprising layers of kraft paper with an internal honeycomb structure are very lightweight due to the large volume of air-filled cells therein, filling such internal cells with gypsum slurry will increase the weight. Thus, the number of apertures may vary based on the desired end weight as well as the desired strength of the final finished composite material. In preferred embodiments, between about 4 to 10 apertures are made per approximately each square foot core material, approximately evenly spaced. More preferably, 4 to 6 apertures are made per square foot of surface, approximately evenly spaced. Similarly, in preferred embodiments about 8% to about 22% of each surface of the panel is removed to make the apertures more preferably about 9% to about 13% of the surface, most preferably 10% to 12% of the surface is removed in making evenly spaced apertures in each surface.

Reinforcement of the honeycomb panels may be accomplished either before or after such panels are cut to the appropriate size and shape for the intended application. That is, the kraft paper honeycomb may be cut to size, then the fiberglass reinforcement applied to both flat surfaces, or kraft paper honeycomb sheets may be reinforced on each side, then cut to the desired size and shape of the intended end products, which may be desirable when manufacturing many end products in a single facility. If reinforcing a sheet of kraft paper honeycomb, then cutting to size, machine tools, such as a CNC router, may be used to both cut the reinforced honeycomb to size and cut the desired aperture using the same process.

### Other Core Materials

Composites in accordance with the invention include a reinforced core material. Due to its low cost of manufacture, for table top, counter top, and other similar applications, the fiber-reinforced kraft paper core, such as the fiber-reinforced resin-treated paper honeycomb core described above is generally preferred. However, other core materials, such as many other core materials commercially available, may be used, and in some applications may be preferred even if they are a higher cost. One such alternate core material is aluminum composite material, such as the aluminum-clad polystyrene (aluminum bonded to both sides of a polystyrene core) sold commercially under the brand name Alucabond® and Alucabond® PE. Using alternate core materials such as aluminum composite material, which is flexible, can allow for embodiments of the present invention to be used for manufacture of non-flat surfaces, such as structural or decorative columns. Thus, in the methods and the finished composite materials described herein, cores other than fiber-reinforced resin-treated paper cores may be used.

### Cast Gypsum

Composite surfaces according to the invention and methods of making such surfaces include calcium sulfate hemihydrate (95%+) referred to herein as gypsum, also referred to herein as gypsum cement. Alpha gypsum, or alpha hemihydrate, is preferred, due to its superior strength characteristics, but in some applications beta gypsum may be used. In the method embodiments described herein, a gypsum slurry is used comprised of gypsum (preferably alpha gypsum), water, and polymer modifiers. Such polymer modifiers are included to improve the characteristics of the gypsum, including to improve water resistance and/or improve adhesion of other layers of the composite with the gypsum. A description of various polymer modifiers that may be used to improve the strength characteristics of gypsum is provided in U.S. Pat. No. 5,879,825, which is incorporated herein by reference. A description of various polymer modifiers that may be used to improve water resistance of gypsum is provided in U.S. Pat. No. 6,492,450, which is incorporated herein by reference.

One preferred polymer modifier is an acrylate copolymer modifier, more preferably an acrylic-styrene copolymer. One such preferred modifier is available commercially as Syntran® 6200 and distributed by Interpolymer. Such polymer modifiers may be commercially available in aqueous suspensions or “liquid” form for ease of use and mixing with gypsum and other dry components. For example, it is common for both dry component (gypsum) and wet components (polymer in water) to be formulated so that they are mixed as two parts dry to one part wet. However, this ratio may be adjusted as needed.

Other optional modifiers may be used to improve the strength, durability, decrease the weight, or otherwise provide desirable characteristics to the gypsum and the finished product. Such modifiers may be used to change the properties of the gypsum layer of the finished composite surface. For example, the gypsum slurry may include a polymer modifier to improve the water resistance of the gypsum layer when cured and/or improve adhesion of other layers of the composite with gypsum layers. Other modifiers may include fillers or other non-polymer materials to, for example, decrease the weight of the cured gypsum components once cured, as compared with the same volume of gypsum without such filler, or reduce cure time. Another preferred modifier is a glass micro cellular filler, more preferably one with irregular and preferably hollow shapes. Such modifiers are sometimes referred to as nanofillers, particularly those with small particle sizes. One such glass microcellular filler is comprised of approximately 73% silicone dioxide, approximately 17% aluminum oxide, approximately 5% potassium oxide, and approximately 3% sodium oxide, and approximately 1% calcium oxide, and is sold as Sil-Cell® by Silbrico Corporation.

Yet another preferable modifier to the gypsum slurry is a cross-linking agent. The selection of an appropriate cross linking agent will depend on the characteristics of the polymer or monomers added to the gypsum. Preferred cross-linking agents for polymers or monomers with carboxyl-functionality are polyaziridines, preferably tri-functional polyaziridines. Such cross-linking agents, when used in conjunction with the polymer modifier with compatible functionality, can interact or crosslink. Such crosslinkages will provide improved water resistance and structural integrity versus a similar gypsum compound without such modifier.

The gypsum slurry is cast into a frame or mold as is otherwise herein described. In method embodiments of the present invention, an aliquot of the gypsum slurry is poured or otherwise deposited into the mold or frame with the desired size or shape. This aliquot, either by gravity or with assistance by moving the mold, using a spreader or spreading tool, or any other known method is spread across the bottom surface of the mold so that such bottom surface of the mold or bottom of the frame backing is covered with the gypsum slurry. Preferably, the slurry is spread so that it is approximately evenly coating the bottom surface.

After the core material is deposited and aligned as needed, the rest of the mold or frame is filled with the gypsum slurry. If any apertures were made in the core material that do not pervade the entire core, the core should be placed such that such apertures are “face up” in the mold or frame and can be filled with the gypsum slurry. Preferably, all voids within the mold or frame and any apertures within the core material are filled with the gypsum slurry. The gypsum slurry may be spread in order to fill such voids and the entire mold using spreading tools, wipers, by shaking the mold or frame, or by other known methods. Preferably, the gypsum slurry is spread to create an approximately even and smooth surface.

One the gypsum slurry is applied, the mold or frame with gypsum and core material should be allowed to cure for a sufficient period of time and under sufficient conditions for the gypsum material to fully solidify. When fully solidified, this gypsum base (gypsum-covered core) may be removed from the mold or frame for further processing.

Optionally, drilling of umbrella holes, sanding of irregular surfaces, and other surface modifications may be made after the gypsum is cured.

### Molds or Frames

As indicated above, methods according to the invention utilize a mold or frame. The mold or frame is intended to approximately reflect the intended size and shape of the finished composite material desired. Such mold or frame may be comprised of any sufficiently structural material that is capable of withstanding gypsum slurry application. Examples include silicone, metals, including aluminum, wood, Styrofoam, and other known materials for making gypsum or plaster molds as known in the art. In preferred embodiments, a silicone mold is used. In other preferred embodiments, an adjustable aluminum frame on a flat, preferably nonstick surface surface is used. Suitable nonstick surfaces include but are not limited to those comprised of or coated with polytetrafluoroethylene (PTFE) or other “cutting board” surfaces and waxed surfaces.

As indicated, the size of the mold or frame selected should reflect the intended approximate size of the finished composite material desired. For most applications, the majority of the volume of the finished product is preferably comprised of the reinforced core material. The length and width, as well as the depth, should be large enough to accommodate the entire reinforced core material with the desired size and thickness of gypsum layer on top, bottom, and surrounding all sides. For most countertop and table top applications, preferred thickness of each gypsum layer is at least ¼ inch thick on the top and bottom, preferably about ¼ inch thick, and about ½ inch on each side or edge. That is, if the intended final surface is to be a table top that is circular with a 48 inch diameter and 1.5 inches thick, the mold or frame would reflect these dimensions, and the preferred honeycomb panel would be 1 inch thick cut to about 47 inches in diameter. However, other applications may demand more or less gypsum support. For example, if the finished product is intended to be a vertical panel, such as a backsplash, wherein a thinner finished product is desired to be about ¾ inch thick, a ½ inch thick honeycomb panel with gypsum layers on each side of the honeycomb and along the edge of the honeycomb panel of about ⅛ inch thick on each surface is preferred. Similarly, if the intended final product is intended to be about 3 inches thick, the honeycomb panel selected for this application may be about 2 to 2.5 inches thick, preferably about 2.25 inches thick with gypsum on the top, bottom, and sides of about ⅜ inch thickness.

### Primer for Decorative Printed Layer

Once the polymer-modified gypsum cement has fully cured, the gypsum core may be removed from the mold or frame and a primer applied to the surface intended to be the top and any exposed sides of the countertop, table top, or other panel surface. This primer can be any primer suitable for use on bare gypsum to prepare a suitable surface for adhering the decorative printed layer, described below, used next to the gypsum surface. Various thermoset primers may be used, including but not limited to polyurethane primers, polyester primers, and epoxy primers. Preferably, such primer will both reduce the porosity of the gypsum surface to which the decorative printed layer is applied and provide a surface that upon contact with the photographic film or adhered decorative printed scrim will provide or promote a cross-linking bond with such film. A 2-part (also known in the art as 2K or A&B) primer is preferably used, such as a 2K water based polymer coating. A preferred primer is a two part (A&B) epoxy primer, such as an industrial automobile primer. One such preferred primer is 2-part epoxy primer by DuPont known as Nason® Ful-Poxy 491-16 with 483-19 catalyst.

Additives may optionally be added to the primer to optimize adhesion of the photographic scrim or film, to improve coloration of the finished product, or provide other desirable qualities. For example, color pigments, including but not limited to iron oxide pigments, titanium dioxide pigments, carbon black, or extenders, including but not limited to kaolin, mica, and other earthen minerals, organic pigments, and synthetic extenders and pigments may be added. In embodiments wherein a printed photographic scrim is later applied, the primed surface is preferably white. Preferably, the primer coating should be mixed and applied in a manner to best allow for even coating of the intended surfaces of the gypsum core. More preferably, the primer is applied by spraying the mixed primer onto the gypsum core. The primer should then be allowed to cure.

### Decorative Printed Layer

Once the gypsum core is primed, a decorative printed scrim or photographic film, each referred to herein as decorative printed layer, is applied to the top, top and sides, or any outward surface or surfaces of the core. Preferably, this decorative printed scrim or photographic film has a high-quality, high-resolution image printed on it. In some embodiments, high-resolution photographs of natural materials, such as granite, marble, travertine and other limestone, wood, soapstone, slate, quartz, and other expected natural designs may be depicted. Graphics, such as maps, logos, or other drawings, or scenic photographs, close-ups of other natural phenomena, and other designs may also be depicted on the decorative printed layer. Using current technologies that are commercially available, one may use special adhesive scrims with a printer to produce such photo-quality designs on a large enough scale to cover a table top, countertop or other large surface.

In preferred embodiments, the decorative printed layer is an adhesive-backed cast vinyl surface, or photographic film, to which a photographic or other graphic image has been applied using a specialty printer. One such photographic film product currently available on the market is distributed by 3M as Control-Tac™ graphic film and compatible inks, including but not limited to 3M Screen Printing Ink Series 1900 and 3M Screen Printing UV Ink Series 9800. When used with a compatible printer and inks as is used in sign-making, vinyl-decal, and other arts, such images can be made at a high resolution with significant resistance to fading and other degradation. More preferably, an ultraviolet-cured (UV-cured) ink is used on a compatible photographic film, then cured with application of UV light.

In other embodiments, the decorative printed layer may be a scrim designed for printing, as are commercially available and known in the sign-making and banner making arts. Any scrim that is suitable for both design printing and application to a solid material (as described below) may be used, and many variants of printable scrims or fabrics, including the materials, thicknesses, and weave characteristics are commercially available. In preferred embodiments of the invention, a 10 mil polyester rayon scrim suitable for UV printing and/or dye sublimation printing with a compatible printer has been used.

The decorative printed layer is preferably a photographic film applied by carefully aligning the film such that the desired designs are in the proper position of the countertop, tabletop, or other intended surface, then removing the backing and carefully applying the adhesive face of such film to the surface of the table top, counter top, or panel. In preferred embodiments, the film may be smoothed out by applying even pressure to the top surface of it using a rolling, smoothing, or other tool or applying pressure with the hands directly to remove or minimize air pockets and maximize the contact between the film and the primed surface so that cross-linking may best occur between the adhesive of the photographic film layer and the surface primer. Similarly, folding and other overlaps of the surface should be avoided and minimized on the intended top, sides, or any other intended decorative surfaces.

Where a printed scrim is used, such scrim should be similarly applied by aligning the design in the proper position of the countertop, table top, or other intended surface. Similar to the application of fiberglass scrim as applied herein, to adhere the printed scrim to the primer o the surface of the gypsum, a mixed epoxy is applied.

Preferably the decorative printed layer is flexible, such that it may be stretched over and around areas to minimize folding and air pockets. Some amount of excess decorative printed scrim is expected to extend to the underside or back side of the intended decorative surface, preferably at least about half an inch or more, and additional excess of the decorative printed layer on the underside or intended non-decorative side of the surface may be trimmed off both before and after application of the adhesive photographic film or application of the epoxy or other material to adhere the decorative printed layer.

### Sealer and Other Top Coats

In methods according to the invention, at least one clear sealant or polymer resin top coat is applied. Such sealant or polymer resin top coat may be applied with any appropriate method, including spraying, pouring and rolling, submersing, brushing, or any similar methods or combination of such methods for applying such a sealant as is known in the art. For example, sealant may be poured into the mold and the surface submersed in such, then coated with a roller. As the design on the decorative printed scrim is intended to show through, a transparent or nearly transparent sealant is preferably. A multi-component sealant comprising a primer and top sealer may also be used in accordance with the invention.

One preferred sealant is a multicomponent or 2-part urethane synthetic resin sealant. One such 2-part urethane synthetic resin sealant is marketed by Nason® as Select-Clear 2K urethane multi-panel clear finish.

Additional clear polymer topcoat or other coatings may also be applied for added durability, visual balance, sheen adjustment, stain resistance, and to further provide an anti-microbial surface as needed. Preferred polymer topcoats include clear polyaspartic or aliphatic polyurea coatings. Such preferred polyaspartic coatings provide UV stability to prevent discoloration, and increased weather and small impact resistance. Multiple coats of such topcoats may be applied, and the surface may be finished with a gloss or matte finish as desired. Some preferred clear polyaspartic top coat used in embodiments of the invention are those currently sold by Bayer using the brand names Desmodur® (isocyanates) and Desmophen® (resin) brands.

In some preferred embodiments, a water-based polyurethane may be applied as a topical treatment to, for example, adjust the sheet of the finish. Various additives may also be used in the coatings. In some embodiments, a fluoropolymer performance additive is added to the water-based polyurethane coating prior to its application.

Embodiments of the invention rely on utilizing advanced chemical formulas, polymer modified alpha gypsum cement, structural composite materials and specialty functional polymer resins that are compatible and developed to provide a balanced and structural decorative table top or panel that will endure many years of all weather conditions and UV sun exposure without failure, pre-mature degradation or short term failure.

### Composites

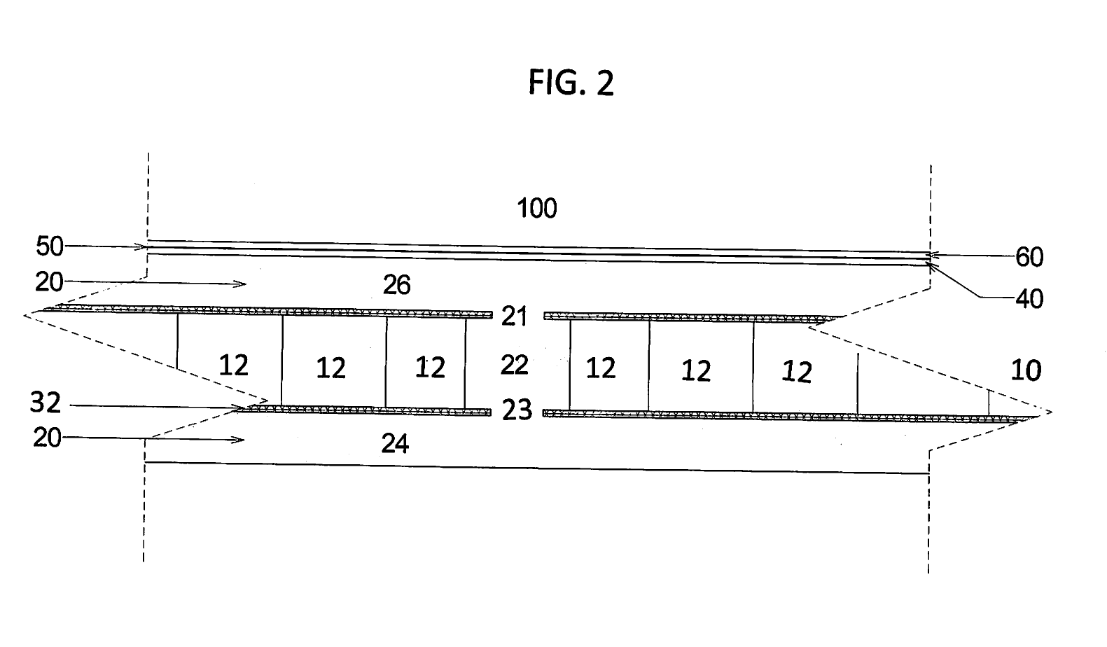

Embodiments of the invention further comprise composite surfaces with the structure that can be made by the processes described herein. As shown in FIG. 2, composite embodiments of the invention include composite materials 100, such as counter tops, table tops, decorative panels comprising a core material 10, a top reinforcement layer 30 on the top surface of the core material, a bottom reinforcement layer 32 on the bottom surface of the core material, a gypsum layer surrounding such reinforcement layers and core material including as portions a top gypsum layer 26, a bottom gypsum layer 24, and a perimeter gypsum layer; a decorative film layer 50 over at least one surface of the gypsum layer, and at least one sealant layer 60. Such composite material may also comprise a primer layer 40 between a top surface of the top portion of the gypsum 26 and the decorative film layer 50. Such composite material may also include gypsum support columns 22 within said core, such gypsum support columns extending from the top gypsum layer 26 to the bottom gypsum layer 24 through apertures in the top reinforcement layer and bottom reinforcement layer 21, 23 and extending through the core materials. Such gypsum support columns may also be continuous with the gypsum layer and forming a unitary, unbroken gypsum structure.

As described herein, the gypsum may include various additives and modifiers such as polymer modifiers and nanofillers. In preferred embodiments for table top and counter top applications, the core is comprised at least one honeycomb panel comprised of kraft paper arranged to form air-filled hexagonal cells 12 with at least one top kraft paper surface and at least one bottom kraft paper surface of such panels, as has been previously described herein. The reinforcement layer in such preferred embodiments may be further comprised of woven fiberglass scrim within and epoxy layer 30 as has been further described herein.

Curved or shaped composite embodiments according to the invention may include an aluminum-clad polystyrene core, a gypsum layer surrounding such aluminum-clad polystyrene core, a decorative film layer over at least one surface of the gypsum layer, and at least one sealant layer. Such embodiments may further comprise one or more gypsum supports within said aluminum-clad polystyrene core.

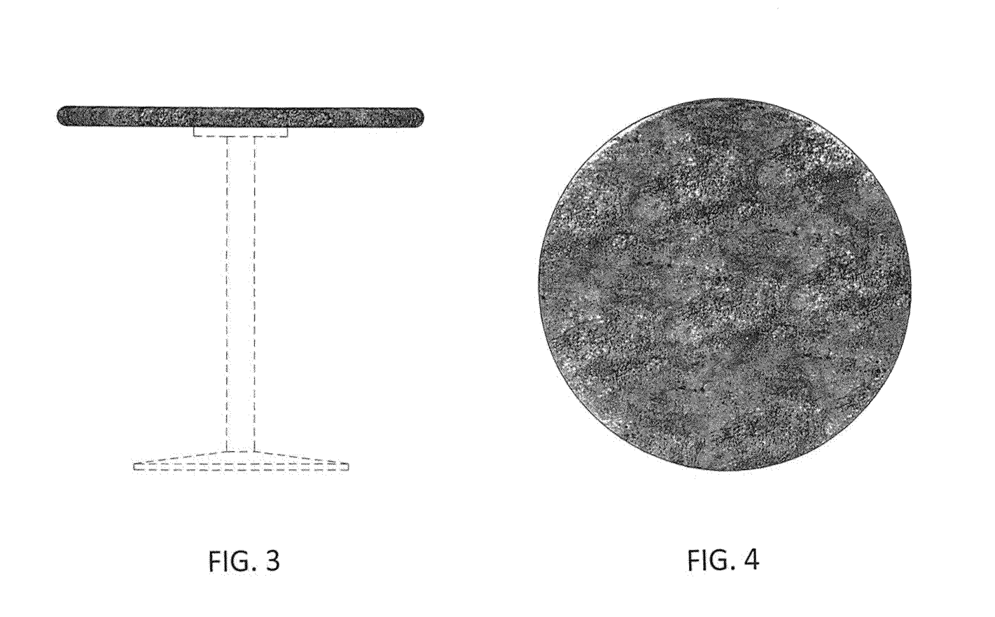

An important feature that has not been heretofore described in detail is that the printed decorative layer can have intricate, photo-quality designs. Thus, for various applications, the design applies can be a photograph of a natural material, such as marble, granite, sandstone, or some other desirable decorative surface. Thus, the finished surface is made to look like a natural surface, but has improved and desirable characteristic. As shown in FIG. 3 and FIG. 4, the finished composite surface can mimic the look of granite or another desirable material. Likewise, with the gypsum underside, it can easily be attached to table bases, cabinets, column frames, or other desired objects.

This invention solves many problems and issues when commonly compared to current decorative table tops or panels when used for exterior applications. This invention provides superior all weather durability and UV stability while maintaining its structural integrity and original manufactured appearance. This invention solves the issues of warping, cupping fading and surface degradation common to traditional or current exterior decorative table tops or panels.

For example, a 48 inch, 1.5 inch thick composite tabletop with multiple gypsum supports as a unitary structure approximately over 10-12% of its internal core surface displays tremendous durability, yet is 65% lighter than a marble table top of the same size. Similarly, such composite materials are more shatter-resistant than natural stone, and are estimated to be able to endure a force approximately 500% greater than the tensile forced endured by most natural stone products before breaking In one trial of a composite table top embodiment of the invention, such table top was dropped off a roof and did not break. In another trial of a 12-foot long, 1.5 inch thick composite tabletop with approximately 5, 1-inch diameter gypsum supports included every square foot as a unitary structure with the gypsum layers on flat surfaces, 500 lb of force was applied to the center of the table top structure for 24 hours, and no measurable bowing was observed.

Composite surfaces according to the invention may also be repaired and resurfaced, both on-site and in a manufacturing facility. In fact, the entire design of such a surface may be easily changed. If needing to repair or change the decorative surface of such a composite surface, one could first clean the top sealed surface of the composite table top, counter top, or panel and, if needed, sand, fill, and repair or reglue as needed. If further surface preparation is needed to ensure adherence of the new photographic film layer is needed, another primer layer could be applied as was previously described herein and allowed to cure. Then, a new photographic film layer with the new desired decorative design thereon can be applied to this new primer surface and smoothed using similar methods as has previously described herein. Additional sealant layers, preferably including another polyaspartic sealant layer would be applied and allowed to cure, and the table top or counter would be repaired and ready for use again.

Thus, embodiments of the present invention also include composite surfaces further comprising a second primer layer on top of the previously-described sealant layer, a second decorative graphic film layer over this second primer layer, and additional sealant layers on top of this second graphic film layer.

1. A composite material comprising:
a. a reinforced core panel comprising:
i. a honeycomb sandwich panel comprising a top sandwich layer, a bottom sandwich layer, and a honeycomb layer, said honeycomb layer comprised of a multiplicity of cells, wherein said cells are traverse to said top sandwich layer and bottom sandwich layer;
ii. a rigid top reinforcement layer atop said top sandwich layer iii. a rigid bottom reinforcement layer below said bottom sandwich layer, wherein said rigid top reinforcement layer and bottom reinforcement layer define reinforced core panel edges;
b. a top gypsum layer on top of said rigid top reinforcement layer, said gypsum layer comprised of a mixture comprising alpha hemihydrate gypsum and polymer modifier,
c. a bottom gypsum layer below said rigid bottom reinforcement layer, said bottom gypsum layer comprised of a mixture comprising alpha hemihydrate gypsum and polymer modifier;
d. a perimeter gypsum layer around said core panel edges and extending from the edge of the top reinforcement layer to the bottom reinforcement layer throughout the entire perimeter of each said reinforcement layer, said perimeter gypsum layer comprised of a mixture comprising alpha hemihydrate gypsum and polymer modifier
e. a core primer layer adjacent and along the entire surface of said top gypsum layer
f. a printed decorative layer adjacent and along the entire surface of said core primer layer,
g. at least one sealant layer adjacent and along the entire surface of said printed decorative layer, wherein said sealant layer is transparent or translucent.

2. The composite material as claimed in claim 1, wherein one at least one set of aligned apertures are in said rigid top reinforcement layer, said rigid bottom reinforcement layer, said top sandwich layer, and said bottom sandwich layer, and further comprising:
h. at least one gypsum support column, said gypsum support column extending from said top gypsum layer through the aligned apertures through said rigid top reinforcement layer, said top sandwich layer, said bottom sandwich layer, and said rigid bottom reinforcement layer, said gypsum support column also filling a cell within said honeycomb layer.

3. The composite material as claimed in claim 2, wherein said at least one gypsum support column is unitary with said top gypsum layer and said bottom gypsum layer.

4. The composite material as claimed in claim 2, wherein at least 10% of said cells are filled with gypsum.

6. The composite material as claimed in claim 2, wherein said honeycomb sandwich panel is comprised of at least kraft paper and at least 1-inch thick, and wherein said top gypsum layer is at least ¼ inch thick and said bottom gypsum layer is at least ¼ inch thick.

7. The composite material as claimed in claim 1, wherein said honeycomb sandwich panel is comprised of kraft paper.

8. The composite material as claimed in claim 1, wherein said rigid top reinforcement layer is comprised of aluminum.

9. The composite material as claimed in claim 8, wherein said rigid bottom reinforcement layer is comprised of aluminum.

10. The composite material as claimed in claim 1, wherein said at least one sealant layer is comprised of a polyaspartic coating.

11. The composite material as claimed in claim 1, wherein said top gypsum layer and said bottom gypsum layer at are least ⅛ inch thick.

12. The composite material as claimed in claim 1, wherein said top gypsum layer and said bottom gypsum layer are at least ¼ inch thick.

13. A method of making a composite panel comprising:
a. depositing an aliquot of wet cast polymer-modified alpha gypsum cement slurry into a mold,
b. inserting a reinforced core panel into said mold atop said aliquot of wet cast polymer-modified alpha gypsum cement,
c. depositing additional wet cast polymer-modified alpha gypsum cement slurry to fill the mold,
d. allowing said polymer-modified alpha gypsum cement slurry to solidify, thus forming a gypsum base with at least one flat gypsum surface,
e. removing said gypsum base from said mold,
f. applying a thermoset primer to said at least one flat gypsum surface of said gypsum base,
g. applying a decorative printed layer to said primed at least one flat surface,
h. applying a transparent sealant to said decorative printed layer.

14. The method as claimed in claim 13, wherein said thermoset primer is further applied to the edges of said gypsum base, and said decorative printed layer is applied to the primed edges of said gypsum base.

15. The method as claimed in claim 14, wherein said reinforced core panel two flat surfaces and multiple holes extending through the reinforced core panel, and wherein said additional wet cast polymer-modified alpha gypsum cement slurry fills said holes.

16. The method as claimed in claim 13, further comprising:
a. making a reinforced core panel by:
i. obtaining a honeycomb sandwich panel comprising a top sandwich layer, a bottom sandwich layer, and a honeycomb layer, said honeycomb layer comprised of a multiplicity of cells, wherein said cells are traverse to said top sandwich layer and bottom sandwich layer,
ii. applying fiberglass scrim to said top sandwich layer and said bottom sandwich layer using an epoxy resin, making a fiberglass-reinforced honeycomb sandwich panel, and
iii. cutting said fiberglass-reinforced honeycomb sandwich panel to the desired panel size and shape.

17. The method as claimed in claim 16, said making a reinforced core panel step further comprising:
iv. making a plurality of holes in said fiberglass reinforced honeycomb sandwich panel, said holes extending through the top and bottom fiberglass layers, the top sandwich layer, the bottom sandwich layer, and the honeycomb layer.

18. The method as claimed in claim 13, wherein said primer is a 2-part water based primer.
